(19) United States
(12) Patent Application Publication
(10) Pub. No.: US 2021/0016686 A1
(43) Pub. Date: Jan. 21, 2021

(54) SEAT ASSEMBLY AND METHOD

(71) Applicant: Lear Corporation, Southfield, MI (US)

(72) Inventors: Arjun Yetukuri, Rochester Hills, MI (US); Karl Henn, New Hudson, MI (US)

(21) Appl. No.: 16/514,613

(22) Filed: Jul. 17, 2019

(51) Int. Cl. B60N 2/02; B60N 2/90; B60N 2/56; B60N 2/00

(52) U.S. Cl. CPC B60N 2/0244; B60N 2/976; B60N 2002/0268; B60N 2/5621; B60N 2/002; B60N 2/5678

(57) ABSTRACT

A seat assembly includes a seat having a seat base and a seat back, an adjustment assembly configured to adjust the seat, an electronic control unit (ECU) connected to the seat and the adjustment assembly, and/or a sensor assembly connected to the ECU. The ECU may be configured to receive (e.g., continuously) audio in a vehicle cabin via the sensor assembly and to automatically control the adjustment assembly to adjust the seat.

### TECHNICAL FIELD

The present disclosure generally relates to a seat assembly, such as a seat assembly that may be used in connection with a vehicle.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some seat assemblies may not provide sufficient functionality and/or may not be configured for automatic adjustments.

There is a desire for solutions/options that minimize or eliminate one or more challenges or shortcomings of seat assemblies. The foregoing discussion is intended only to illustrate examples of the present field and should not be taken as a disavowal of scope.

SUMMARY

In embodiments, a seat assembly may include a seat having a seat base and a seat back, an adjustment assembly configured to adjust the seat, an electronic control unit (ECU) connected to the seat and the adjustment assembly, and/or a sensor assembly connected to the ECU. The ECU may be configured to receive (e.g., continuously) audio in a vehicle cabin via the sensor assembly and to automatically (i) control the adjustment assembly to adjust the seat, and/or (ii) control the sensor assembly, according to the received audio. The ECU may be configured to automatically control the adjustment assembly to adjust the seat according to the received audio independent of any static list of predetermined or stored voice commands or wake-up phrases. A seat assembly may include an audio filter unit connected to the ECU. The audio filter unit may be configured to separate a voice of an occupant from ambient noise in said vehicle cabin. The received audio may include a first occupant voice, a second occupant voice, and the ambient noise. The audio filter unit may be configured to substantially filter out the ambient noise from the first occupant voice to provide a first signal. The audio filter unit may be configured to substantially filter out the ambient noise from the second occupant voice to provide a second signal. The ECU may be configured to adjust the seat according to the first signal and/or to adjust a second seat according to the second signal.

With embodiments, the adjustment assembly may include an audio unit. The adjustment assembly may include a seat position unit configured to adjust positions of the seat back and the seat base according to the received audio. The adjustment assembly may include a massage unit having one or more massagers disposed in at least one of the seat base and the seat back. The ECU may be configured to activate the one or more massagers according to the received audio. The adjustment assembly may include a temperature control unit. The ECU may be configured to increase and/or decrease a temperature of said vehicle cabin via the temperature control unit. The ECU may be configured to control seat heating and seat ventilation functions of the temperature control unit that may be connected to the seat base and/or the seat back. The ECU may be configured to identify an occupant in the seat via the sensor assembly. The sensor assembly may include a biometric sensor. The ECU may be configured to recognize a previous occupant via the biometric sensor.

In embodiments, a method of operating a seat assembly may include providing a seat, an electronic control unit (ECU), a sensor assembly, a microphone assembly disposed proximate the seat, and an adjustment assembly; detecting an occupant in the seat via the sensor assembly; continuously receiving audio via the microphone assembly; and/or activating, via the ECU, the adjustment assembly to adjust the seat of the occupant according to the received audio. Detecting the occupant may include (i) the ECU receiving information from a biometric sensor of the sensor assembly; (ii) comparing the information to a database stored in the ECU; and/or (iii) loading a respective occupant profile. Detecting the occupant may include (i) the ECU receiving information from a biometric sensor of the sensor assembly; (ii) comparing the information to a database to identify a corresponding occupant profile; and/or (iii) creating an occupant profile for the corresponding occupant. The ECU may be configured to receive information from the sensor assembly while the occupant is disposed in the seat. The method may include transmitting the received audio to a filter unit. The filter unit is configured to filter out ambient noise from the received audio to isolate a voice of the occupant. The received audio may correspond to a physical condition of the occupant. Activating the adjustment assembly may include activating at least one of a seat position unit, a massage unit, a temperature control unit, and an audio unit. The method may include, after activating the adjustment assembly, automatically requesting and receiving, via the ECU, feedback from the occupant regarding the activation of the adjustment assembly. The ECU may be configured to update a corresponding occupant profile with the feedback from the occupant. The ECU may be configured to use the feedback in determining future adjustments of the same occupant.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is a side view of portions of an embodiment of a seat assembly according to teachings of the present disclosure.

FIG. 2 is a schematic of portions of an embodiment of a seat assembly according to teachings of the present disclosure.

FIG. 3 is a schematic of portions of an embodiment of a seat assembly according to teachings of the present disclosure.

FIG. 4 is a flow chart generally illustrating an embodiment of a method of operating a seat assembly according to teachings of the present disclosure.

FIG. 5 is a flow chart generally illustrating an embodiment of a method of operating a seat assembly according to teachings of the present disclosure.

FIG. 6 is a flow chart generally illustrating an embodiment of a method of operating a seat assembly according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they are not intended to limit the present disclosure to these embodiments and/or examples. On the contrary, the present disclosure is intended to cover alternatives, modifications, and equivalents.

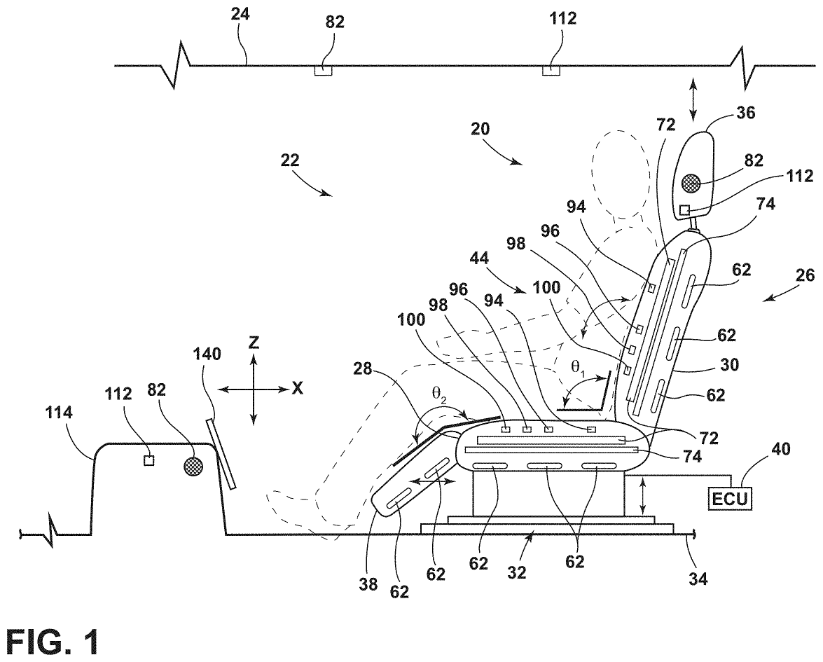

In embodiments, such as generally illustrated in FIG. 1, a seat assembly 20 may be configured to monitor sounds in a vehicle 24, such as in a cabin 22 of the vehicle 24, and/or may be configured to analyze the received/detected sounds to determine an action. The seat assembly 20 may be disposed in and/or connected to a cabin 22 of a vehicle 24. The seat assembly 20 may include a seat 26 that may include a seat base 28 and/or a seat back 30, either or both of which may be configured for selective adjustment/movement. The seat 26 (e.g., the seat base 28) may be connected to a track assembly 32 that may be disposed on the floor 34 of the vehicle 24. The seat base 28 and/or the seat back 30 may be adjustable relative to each other and/or the vehicle floor 34, such as via the track assembly 32. The seat base 28 may be selectively connectable to the track assembly 32. The seat 26 may be configured to move in the Z-direction with respect to the track assembly 32. The seat assembly 20 may be configured to receive/detect audio from an occupant 44 that may be seated in the seat 26 and/or in the vehicle cabin 22.

With embodiments, a seat assembly 20 may include an electronic control unit (ECU) 40. The ECU 40 may be disposed in the vehicle 24, such as in the vehicle cabin 22 or outside the vehicle cabin 22. The ECU 40 may be disposed in the seat assembly 20 and/or the ECU 40 may be disposed at a front and/or rear of the vehicle 24. The ECU 40 may be connected to the seat 26 and/or an adjustment assembly 42 associated with the seat 26 such that the ECU 40 may adjust/move the seat base 28 and/or the seat back 30. The ECU 40 may be configured to control one or more of a variety of adjustments of a seat 26. For example and without limitation, the ECU 40 may be configured to control one or more portions/units of the adjustment assembly 42, such as a seat position unit 50, a massage unit 60, a temperature control unit 70, an audio unit 80, and/or one or more other units (e.g., lumbar, cushion extension, etc.). At least some portion of the ECU 40 may be active/on at substantially all times (e.g., even if an ignition or key-on of the vehicle 24 is not active) such that the ECU 40 may be configured to adjust the seat 26 whenever occupied by an occupant 44 (e.g., a driver and/or a passenger).

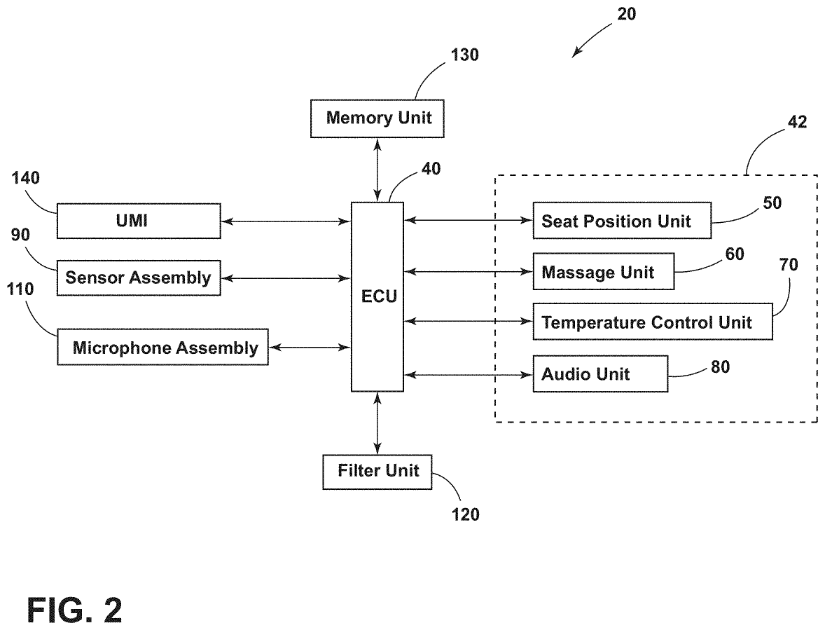

With embodiments, such as generally illustrated in FIGS. 1 and 2, a seat assembly 20 may include a seat 26 and/or an adjustment assembly 42. The adjustment assembly 42 may, for example and without limitation, include a seat position unit 50, a massage unit 60, a temperature control unit 70, and/or an audio unit 80. The seat position unit 50 may be configured to adjust the position of a vehicle seat 26 in the X-direction, the Y-direction, and/or the Z-direction (e.g., raise and lower the seat 26), rotate the seat 26, tilt the seat 26, and/or provide one or more adjustments. The seat position unit 50 may be configured to change (e.g., adjust) an angle θ₁ between the seat base 28 and the seat back 30. For example and without limitation, the ECU 40 may increase and/or decrease the angle θ₁ between the seat base 28 and the seat back 30 via the seat position unit 50. The seat position unit 50 may be configured to raise and lower a headrest 36 that may be connected to the seat back 30. The seat 26 may include a leg support 38 that may be pivotally and/or slidably connected to the seat base 28. The ECU 40 may be configured to change an angle θ₂ between the seat base 28 and the leg support 38 and/or slide the leg support 38 relative to the seat base 28.

In embodiments, a seat assembly 20 and/or and adjustment assembly 42 may include a massage unit 60. The ECU 40 may be configured to control the massage unit 60. The massage unit 60 may include one or more massagers 62 (e.g., haptic devices). The massage unit 60 may be configured to control the massagers 62, which may be disposed in the seat base 28, the seat back 30, and/or the leg support 38. For example and without limitation, the seat base 28, the seat back 30, and/or the leg support 38 may include one or more massagers 62. The ECU 40 may be configured to selectively activate the one or more massagers 62 to target specific areas of an occupant 44 (e.g., legs, back, neck, etc.).

With embodiments, a seat assembly 20 and/or an adjustment assembly 42 may include a temperature control unit 70. The ECU 40 may be configured to control the temperature control unit 70. The temperature control unit 70 may be connected to and/or include at least portions of an HVAC (heating ventilation air conditioning) system (e.g., fans, air conditioning units, heaters, etc.) of a vehicle 24. The temperature control unit 70 may be configured to change the temperature of air in the vehicle cabin 22 and/or direct air flow within the vehicle cabin 22. The temperature control unit 70 may be configured to control the temperature proximate specific seats 26 of the seat assembly 20. The temperature control unit 70 may include one or more seat ventilators/coolers 72 and/or one or more heating elements 74 that may be disposed in the seat base 28 and/or the seat back 30. The seat ventilators 72 may be configured to decrease the temperature of the surface (e.g., seating surface) of the seat base 28 and/or the seat back 30. The heating elements 74 may be configured to increase the temperature of the surface (e.g., seating surface) of the seat base 28 and/or the seat back 30. The temperature control unit 70 may be configured to activate the seat ventilators 72 and/or heating elements 74. The ECU 40 may control the temperature control unit 70 to increase and/or decrease the temperature at or about the seat base 28 and/or the seat back 30 (e.g., by heating and/or providing air movement/circulation).

In embodiments, a seat assembly 20 and/or an adjustment assembly 42 may include an audio unit 80. The ECU 40 may be configured to control the audio unit 80. The audio unit 80 may include one or more speakers 82 that may be disposed at least partially in the vehicle cabin 22. The speakers 82 may be disposed on or about the seat base 28, the seat back 30, and/or the headrest 36. The speakers 82 may be connected to the ECU 40 such that the ECU 40 may interact with an occupant 44 via the speakers 82. The ECU 40 may communicate with the occupant 44 via the audio unit 80 and/or a sensor assembly 90 to receive feedback and/or determine an adjustment action.

In embodiments, a seat assembly 20 may include a sensor assembly 90. The sensor assembly 90 may include one or more sensors. The sensor assembly 90 may be configured to collect data corresponding to an occupant 44 and/or the seat assembly 20. The sensor assembly 90 may be connected to the ECU 40 to transmit information to the ECU 40 and/or the ECU 40 may be configured to analyze the information from the sensor assembly 90 (e.g., when determining an adjustment action and/or a response). The sensor assembly 90 may include a camera 92 that may be configured to capture images and/or video of an occupant 44. The camera 92 may, for example and without limitation, be configured for low-light and/or no-light conditions.

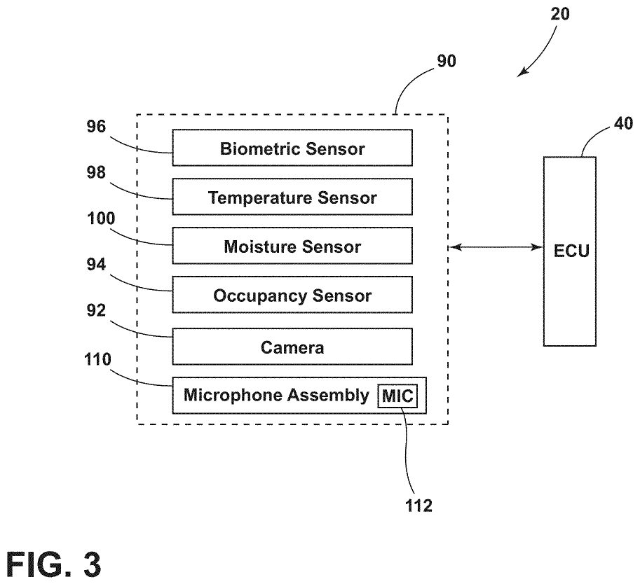

With embodiments, such as generally illustrated in FIGS. 1 and 3, a sensor assembly 90 may include an occupancy sensor 94. The occupancy sensor 94 may be configured to determine whether an occupant 44 is occupying (e.g., seated in) a specific seat 26. The occupancy sensor 94 may detect a weight and/or a pressure on the seat base 28 and/or the seat back 30. The occupancy sensor 94 may be connected to the ECU 40, and/or the occupancy sensor 94 may transmit data to the ECU 40. The ECU 40 may communicate with the sensor assembly 90 to verify than an occupant 44 is in a seat 26 before activating the sensor assembly 90 and/or before activating the adjustment assembly 42. The ECU 40 may be configured to identify whether the occupant 44 is in a driver seat and/or a passenger seat. The ECU 40 may be configured to perform actions corresponding to the respective seat 26 of the occupant 44.

With embodiments, a sensor assembly 90 may include a biometric sensor 96. The biometric sensor 96 may be configured to measure and/or collect characteristics of an occupant 44 (e.g., heart rate, breathing rate, heart rate variability, pulse, respiration, etc.). The biometric sensor 96 may be disposed in the seat 26. The biometric sensor 96 may be disposed in the seat base 28 and/or the seat back 30 such that the occupant 44 may contact the biometric sensor 96. The biometric sensor 96 may be disposed substantially towards, at, or about a seating surface of the seat base 28 and/or the seat back 30 to increase the reliability of data collected by the biometric sensor 96. For example and without limitation, the closer the biometric sensor 96 may be to an occupant 44, the more reliable the data collected by the biometric sensor 96 may be.

In embodiments, a sensor assembly 90 may include a temperature sensor 98. The temperature sensor 98 may be configured to measure and/or collect temperature information of the seat base 28, the seat back 30, and/or the occupant 44. A temperature sensor 98 may be disposed in the seat base 28, the seat back 30, and/or the headrest 36. The temperature sensor 98 may be disposed substantially towards a seating surface (e.g., an outer surface) of the seat base 28, the seat back 30, and/or the headrest 36.

With embodiments, a sensor assembly 90 may include a moisture sensor 100 (e.g., a humidity sensor). The moisture sensor 100 may be configured to measure and/or collect moisture data on or near the seat base 28 and/or the seat back 30. The moisture sensor 100 may be configured to detect the presence of liquid and/or humidity levels on or near a surface of the seat base 28, the seat back 30, and/or the headrest 36. The moisture sensor 100 may be configured to detect whether an occupant 44 is sweating when in contact with or proximity to the seat base 28, the seat back 30, and/or the headrest 36.

In embodiments, such as generally illustrated in FIGS. 1 and 3, a sensor assembly 90 may include a microphone assembly 110. The ECU 40 may be electrically connected to the microphone assembly 110 such that the ECU 40 may receive information detected or received by one or more microphones 112 of the microphone assembly 110. One or more microphones 112 may be disposed in the vehicle cabin 22 such that the one or more microphones 112 may be able to detect sound/audio in substantially all areas of the vehicle cabin 22. A microphone 112 may be disposed on or about the seat base 28, the seat back 30, and/or the headrest 36. A microphone 112 may be disposed on or about a ceiling of a vehicle cabin 22 and/or on/in a console 114. Increasing the number of microphones 112 may increase the quality of the audio collected by the microphones 112 (e.g., may increase voice clarity). The ECU 40 may be configured to determine (e.g., triangulate) an origin of the detected audio (e.g., a voice) via the one or more microphones 112, the biometric sensors 96, and/or the occupancy sensors 94. The ECU 40 may detect, via the sensor assembly 90, changes in breathing rate, heart rate, and/or movement to indicate that an occupant 44 in a seat 26 may be talking or making noise. The ECU 40 may be configured to directionally locate the source of the audio via the one or more sensors of the sensor assembly 90. The ECU 40 may be configured to identify the occupant 44 that is speaking according to information (e.g., data, signals, values, etc.) received from the sensor assembly 90, such as from the biometric sensor 96 and/or the one or more microphones 112.

With embodiments, a microphone 112 may be configured to receive/collect audio from the vehicle cabin 22 and/or an occupant 44 (e.g., the voice of an occupant 44). The microphone 112 may be connected (e.g., electrically and/or wirelessly) to the ECU 40 such that the ECU 40 may process/analyze the audio input received by the microphone 112. The ECU 40 may be configured to detect voices in the vehicle 24 and/or the ECU 40 may be configured to filter out an input that is not the voice of an occupant 44. For example and without limitation, the ECU 40 and/or the microphone 112 may be connected to and/or include a filter unit 120 (e.g., an electronic filter unit) that may be configured to isolate voices from other sounds (e.g., ambient noise) within the vehicle cabin 22. The ECU 40 and/or the filter unit 120 may be configured to detect, reduce, and/or remove ambient noise from the audio received by the microphone 112. The filter unit 120 may receive an input (e.g., audio and/or related information) from the ECU 40 and/or the microphone 112, and/or the filter unit 120 may transmit an output (e.g., filtered audio and/or associated information) to the ECU 40.

In embodiments, an output from the filter unit 120 transmitted to the ECU 40 may include substantially only one or more voices of one or more occupants 44. The filter unit 120 may be configured to separate one or more voices in a vehicle 24. For example and without limitation, the filter unit 120 may receive input from the microphone 112 that may include the voices of one or more occupants 44. The one or more voices may include a first voice (e.g., from a first occupant 44) and/or a second voice (e.g., from a second occupant 44). The filter unit 120 and/or the ECU 40 may separate the first voice and the second voice into a first signal and a second signal (e.g., separate the voices from each other). The first signal may include/correspond to the first voice, and/or the second signal may include/correspond to the second voice. The ECU 40 may receive the first signal and/or the second signal from the filter unit 120. The ECU 40 may be configured to determine the seat 26 that may correspond to each of the first signal and/or the second signal (e.g., the first voice and/or the second voice). The ECU 40 may be configured to adjust a first seat 26, at least in part, according to the first signal, and/or the ECU 40 may be configured to adjust a second seat 26, at least in part, relative to the second signal.

With embodiments, the ECU 40 may be configured to analyze audio (or associated information) received via the microphone assembly 110 and/or the filter unit 120, such as via natural language processing. For example and without limitation, the ECU 40 may analyze the audio from the filter unit 120 and/or the microphone assembly 110 to determine an action and/or response (e.g., how to operate the adjustment assembly 42). The ECU 40 may be configured to process the vocal input from the filter unit 120 and/or analyze the contents of the input (e.g., the first signal and/or the second signal). The first signal and/or the second signal may or may not be commands corresponding to the adjustment assembly 42. For example and without limitation, the first signal and/or the second signal may include one or more words of phrases that may relate to a condition of the first occupant 44 and/or the second occupant 44. The first signal and/or the second signal may include a statement that may correspond to a condition of the first occupant 44 and/or the second occupant 44. The condition may, for example and without limitation, relate to the temperature of the occupant 44 and/or vehicle cabin 22, the comfort of the occupant 44, soreness and/or fatigue of the extremities of the occupant 44, and/or the sound level and/or content inside the vehicle cabin 22. The ECU 40 may be configured to analyze the first signal and/or the second signal via natural language processing to determine and/or activate (e.g., automatically) a corresponding adjustment function.

In embodiments, the ECU 40 may be configured to analyze one or more of a variety of signals. For example and without limitation, the first signal may include the phrase of an occupant 44 such as “my legs are uncomfortable.” The ECU 40 may determine (e.g., automatically) to activate the massagers 62 of the massage unit 60 proximate the legs of the occupant 44; to adjust the angle θ₂ between the seat base 28 and the leg support 38; and/or to increase leg room of the occupant 44 by moving the seat 26 along the track assembly 32 in the X-direction (e.g., rearward). If the ECU 40 has access to an occupant profile associated with the occupant 44, the ECU 40 may activate the adjustment assembly 42 according to (e.g., based on, utilizing, etc.) information in the occupant profile.

In embodiments, the ECU 40 may be configured to verify an adjustment. The ECU 40 may transmit an inquiry to the corresponding occupant 44 to determine the effectiveness of the seat adjustment in relation to the information received by the microphone assembly 110.

With embodiments, the first signal may, for example, include the phrase of an occupant 44 such as “my back is sore.” The ECU 40 may adjust the angle θ₂ between the seat base 28 and the seat back 30 via the seat position unit 50; the ECU 40 may activate the massagers 62 of the massage unit 60 proximate the back of the occupant 44; and/or the ECU 40 may activate one or more heating elements 74 proximate the back of the occupant 44 via the temperature control unit 70. The first signal may include the phrase of an occupant 44 such as “it is hot.” The ECU 40 may be configured to activate the sensor assembly 90. For example and without limitation, the ECU 40 may receive information from the biometric sensor 96, the temperature sensor 98, and/or the moisture sensor 100 to determine the appropriate seat adjustment. If the ECU 40 senses moisture on the seat back 30 via the moisture sensor 100, the ECU 40 may activate the ventilator 72 of the seat back 30; the ECU 40 may decrease the temperature of the air in the vehicle cabin 22 via the temperature control unit 70; and/or the ECU 40 may direct air flow towards the torso of the occupant 44. If the ECU 40 senses a high temperature of the occupant 44 contacting the seat base 28, the ECU 40 may activate the ventilator 72 of the seat base 28; the ECU 40 may decrease the temperature of the air in the vehicle cabin 22; and/or the ECU 40 may direct air flow towards the legs of the occupant 44. The first signal may include the phrase of an occupant 44 such as “I don't like this music.” The ECU 40 may be configured to adjust/activate the audio unit 80 to change the music, reduce the volume of music, and/or mute the speakers 82 nearest the respective occupant 44.

In embodiments, the ECU 40 may be configured to connect to and/or may include a memory unit 130. The memory unit 130 may be disposed in the vehicle 24, and/or the memory unit 130 may be disposed remotely and connected to the ECU 40. The ECU 40 may be configured access, obtain information from, and/or store information in the memory unit 130 (e.g., via a wireless connection to the remote location, and/or via a wired or wireless connection if the memory unit 130 is disposed in the vehicle 24). The ECU 40 may be configured to access and/or store data on the memory unit 130 during operation of and/or in connection with the seat assembly 20. The ECU 40 may be configured to compare the contents of the first signal and/or the second signal with the information stored in the memory unit 130. For example and without limitation, the ECU 40 may isolate words that may be associated with a condition/feeling of an occupant 44. The ECU 40 may be configured to compare the isolated words with words/phrases (e.g., a word/phrase database) stored on the memory unit 130. The words/phrases of the database may correspond to adjustments of the seat assembly 20. For example and without limitation, words/phrases of the database may correspond to adjustments that the ECU 40 may control of the seat position unit 50, the massage unit 60, the temperature control unit 70, and/or the audio unit 80.

With embodiments, the ECU 40 may be configured for machine learning specific to an identified occupant 44. The ECU 40 may identify whether an occupant 44 is a previous occupant or a new occupant. If the occupant 44 is a previous occupant, the ECU 40 may load an occupant profile from the memory unit 130. If the occupant 44 is a new occupant, the ECU 40 may create a new occupant profile for the occupant 44 and store the new occupant profile (e.g., in the memory unit 130). As the ECU 40 analyzes the first signal and/or the second signal, the ECU 40 may utilize machine learning to adapt to the specific language of an occupant 44. For example and without limitation, the ECU 40 may utilize machine learning to determine the intended adjustment of an occupant 44 that may be associated with one or more words/phrases. The ECU 40 may determine that a word/phrase may relate to a unit 50, 60, 70, 80 of the adjustment assembly 42 for an occupant 44 (e.g., the associated occupant profile). The ECU 40 may store the machine learning information of the occupant 44 with the occupant profile. If the occupant 44 occupies a seat 26, the ECU 40 may automatically load the associated occupant profile, which may incorporate the machine learning from previous interactions with the specific occupant 44. As the ECU 40 adjusts the seat assembly 20 and/or receives feedback from the occupant 44, the ECU 40 may update the associated occupant profile (e.g., the occupant profile may include information indicating what phrases/terms and adjustments are preferred by the occupant 44).

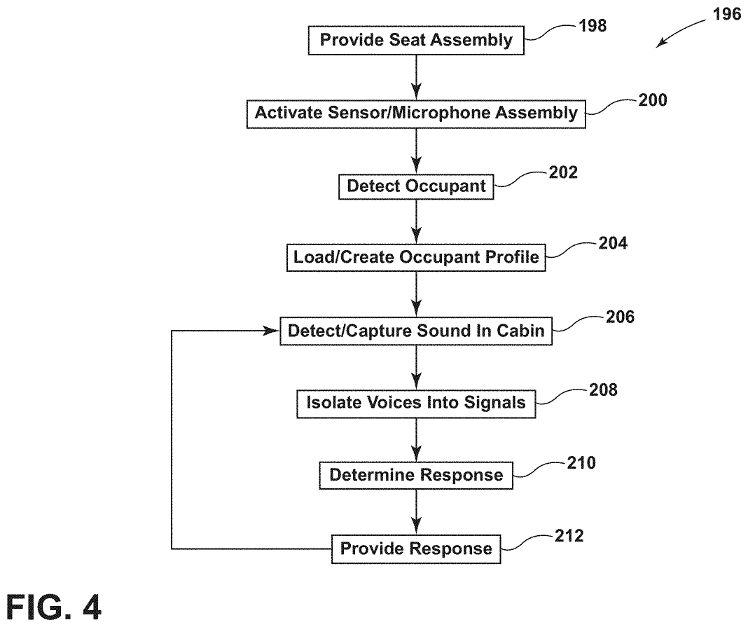

In embodiments, such as generally illustrated in FIG. 4, a method 196 of operating a seat assembly 20 may include providing a seat assembly 20 (step 198), which may include providing a seat 26, an ECU 40, a sensor assembly 90, and/or a microphone assembly 110. The method 196 may include activating the sensor assembly 90 and/or the microphone assembly 110 (step 200). The method 196 may include (i) detecting an occupant 44 (step 202); (ii) loading and/or creating a corresponding occupant profile (step 204); (iii) detecting and/or capturing audio/sound in the vehicle cabin 22 (206); (iv) isolating one or more voices from the sound into one or more signals (step 208); (v) determining a response to the content of the one or more signals (step 210), which may include comparing the one or more signals with information of the memory unit 130 and/or occupant profile; and/or (vi) providing the determined response, which may include interacting with the occupant 44 and/or activating the adjustment assembly 42 (step 212). The method 196 may be at least partially iterative and/or may return to a previous step (e.g., step 206) and continue again.

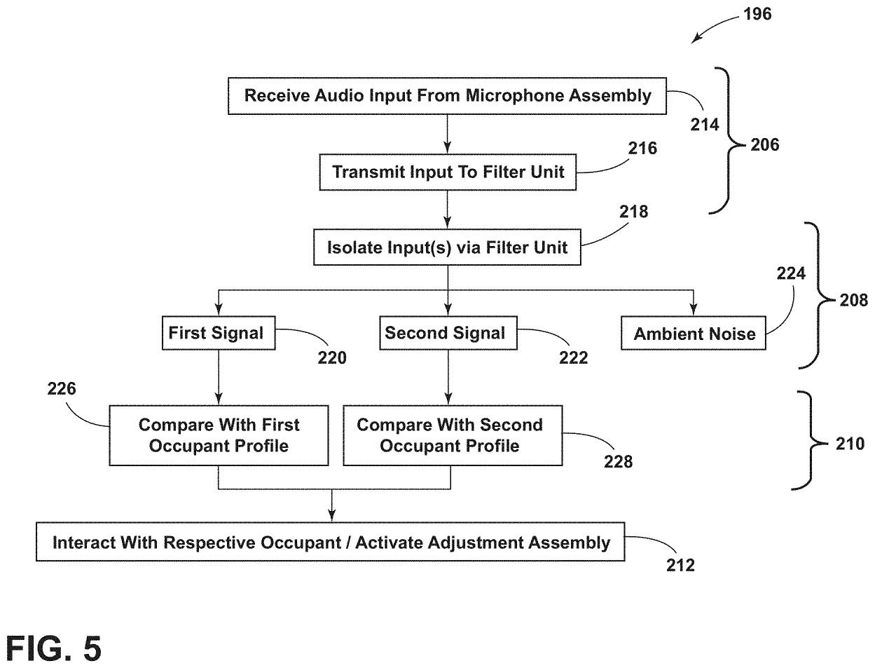

With embodiments, such as generally illustrated in FIG. 5, detecting/capturing audio in the vehicle cabin 22 (step 206) may include receiving audio input from the microphone assembly 110 (step 214) and/or transmitting the received audio to the filter unit 120 (step 216), such as via the ECU 40. Isolating one or more components (e.g., voices) from the received audio (step 208) may include the filter unit 120 isolating and/or separating the received audio into one or more signals (step 218), such as a first signal 220 (e.g., a first voice), a second signal 222 (e.g., a second voice), and/or a third signal 224 (e.g., ambient noise). The filter unit 120 may transmit the one or more signals to the ECU 40 and the ECU 40 may determine how to respond (step 210). Responding may include comparing the first signal with a first occupant profile (step 226), and/or comparing the second signal with the second occupant profile (step 228). The ECU 40 may be configured to compare the content of the signal to the machine learned profile of the occupant 44 to determine the manner in which to activate the adjustment assembly 42.

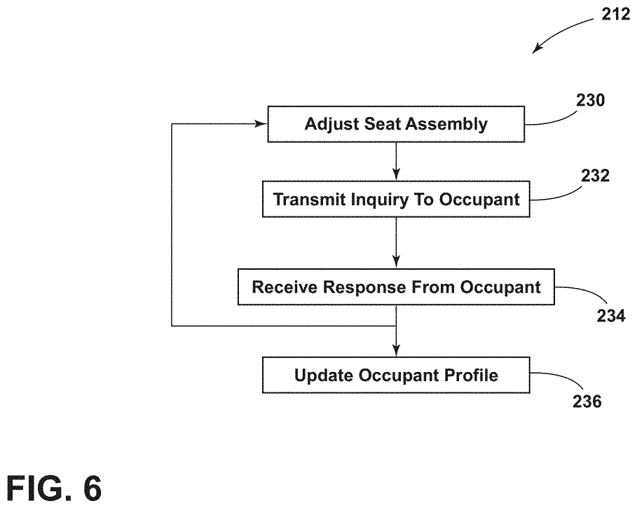

In embodiments, the method 196 may include adjusting a first seat 26 associated with the first signal 220 according to the content (e.g., words, phrases, etc.) of the first signal and/or an occupant profile of the occupant 44 of the first seat 26. Additionally or alternatively, the method 196 may include adjusting a second seat 26 (which may be configured in the same or similar manner as the first seat 26) associated with the second signal 222 according to the content of the second signal 222 and/or an occupant profile of the occupant 44 of the second seat 26 (step 212). Step 212 may, additionally or alternatively, include interacting with the first occupant 44 and/or the second occupant 44 to determine if the occupants 44 desire further adjustment of the first seat 26 and/or the second seat 26, respectively. As generally illustrated in FIG. 6, for example and without limitation, interacting with an occupant 44, such as in response step 212, may include adjusting the seat assembly 20 (step 230), such as via the adjustment assembly 42, and/or may include transmitting an inquiry to the respective occupant 44, such as to confirm whether the adjustment of the respective seat 26 was effective to address the issue identified by the ECU 40 in the received audio (step 232). For example and without limitation, the ECU 40 may transmit an inquiry to a user-machine interface (UMI) 140 and/or may transmit an audio and/or visual inquiry. The UMI 140 may include a display (e.g., touchscreen) that may be disposed proximate the respective seat 26 and/or a console 114 of a vehicle 24.

In embodiments, such as generally illustrated in FIG. 6, response step 212 may include receiving an input (e.g., feedback) from the occupant 44 in response to the inquiry and determining whether additional adjustment is desired (step 234). The ECU 40 may be configured to receive a response and/or feedback from the occupant 44 via the UMI 140 and/or the microphone assembly 110. If the received feedback indicates that the initial adjustment was effective, the ECU 40 may update the corresponding occupant profile (step 236), which may include storing the phrase/term association with the adjustment in the occupant 44 profile (e.g., a form of machine learning specific to the occupant 44 and the occupant profile). If the received feedback indicates that the initial adjustment was not effective or not sufficiently effective, the ECU 40 may adjust the seat assembly 20 again (e.g., return to step 230). Steps 230, 232, and 234 may repeat until the received feedback indicates that the adjustment was effective, at which point the occupant profile may be updated (step 236). For example and without limitation, the ECU 40 may update the occupant profile with adjustments that were not effective for the issue in the received audio and with the adjustment or adjustments that were ultimately effective for the issue.

With embodiments, the ECU 40 may be configured to adjust the seat assembly 20 independently of specific commands or wake-up phrases. For example, rather than requiring an occupant 44 to provide a particular command (which may need to be preceded by a wake-up phrase) to adjust the seat assembly 20, or even deliberately interacting with the seat assembly 20, the ECU 40 may automatically monitor audio in the vehicle 24 (e.g., voices of occupants 44) and automatically adjust or propose adjustments of the seat assembly 20. For example and without limitation, if an occupant 44 says aloud that “my back is sore” (or something similar), such a comment may not typically be considered a command or wake-up phrase, but the ECU 40 may automatically adjust the position of the seat back 30, activate the massage unit 60, and/or activate other portions of the adjustment assembly 42. With some configurations, the ECU 40 may suggest the adjustment to the occupant 44 (e.g., via an audio transmission) prior to initiating the adjustment. If the occupant 44 agrees to the suggested adjustment, which may be captured via the microphone assembly 110 and/or a camera 92 of the sensor assembly 90 (e.g., via a nod of the head of the occupant 44), the ECU 40 may activate the appropriate portion of the adjustment assembly 42.

A few examples of potential interactions between the seat assembly 20 and an occupant 44 are provided below.

TABLE 1
Example 1:
Occupant 44: Feeling cold!
ECU 40: Would you like the seat heaters turned ON?
Occupant 44: Yes.
ECU 40: I turned both cushion and seat back heaters ON. Is that what you
wanted?
Occupant 44: Yes.
ECU 40: Glad I could help.
Example 2:
Occupant 44: Feeling hot!
ECU 40: Would you like the cool feature in the seat turned ON?
Occupant 44: Yes.
ECU 40: I turned the cool feature ON.
Occupant 44: Thank you.
ECU 40: Enjoy.
Example 3:
Occupant 44: I am feeling a bit tired!
ECU 40: Hectic day at work?
Occupant 44: Not really!
ECU 40: Ok. Did you skip your lunch?
Occupant 44: No, can you check how I am doing?
ECU 40: Ok. I can check your pulse and heart rate variability. Here they
are: 80 bpm and HRV is low.
Occupant 44: That explains it! I need to rest.
Example 4:
Occupant 44: My back hurts!
ECU 40: Do you think you have inadequate back support?
Occupant 44: No.
ECU 40: Ok. Is it a specific region or the entire back?
Occupant 44: No, upper back.
ECU 40: Let me turn ON the massagers in that region of the seat.
Occupant 44: Ooh! That feels good!
ECU 40: Hope it helps. I will check back with you in a little while.
[check back]
Example 5:
Occupant 44: My back is getting pushed forward!
ECU 40: Let me recline the seat back a bit.
Occupant 44: Ok.
ECU 40: I reclined the seat. How does it feel now?
Occupant 44: Not much better.
ECU 40: Let me reduce the lumbar support.
Occupant 44: That's a little better!
ECU 40: Let me tilt the seatback forward to its original position.
Occupant 44: That's much better.
Example 6:
Occupant 44: My left leg went to sleep!
ECU 40: Is it numb?
Occupant 44: Yes.
ECU 40: Above the knee, below, or all of it?
Occupant 44: Above the knee.
ECU 40: I will turn On the massage feature in the left bolster.
Occupant 44: Ok.
ECU 40: It's ON now. I will check with you in 5 minutes if your leg feels
any better.
Occupant 44: Ok.

With embodiments, the ECU 40 may be configured to engage in a conversation with an occupant 44, such as to obtain information about the physical well-being of the occupant 44. For example and without limitation, the ECU 40 may ask an initial question to the occupant 44 (e.g., “does your back hurt?”) and then ask one or more follow up questions to the occupant 44 based on the response to the previous question. The ECU 40 may store the questions and/or the responses in the occupant profile, and/or may apply machine learning to the questions/responses. The ECU 40 may activate the adjustment assembly 42 according to information received from the occupant 44 during the conversation.

In embodiments, the ECU 40 may be configured to utilize one or more biometric sensors 96 to directly obtain information about the physical well-being of an occupant 44. The ECU 40 may provide some or all of the information to the occupant 44, such as via an audio transmission and/or via a display (e.g., of the UMI 140).

With embodiments, the ECU 40 may be configured to monitor an occupant 44 prior to, during, and/or after an adjustment of the seat assembly 20. For example and without limitation, the ECU 40 may be configured to automatically transmit a follow up inquiry to the occupant 44 after a period of time (e.g., five minutes, 10 minutes, etc.) following an adjustment of the seat assembly 20. This period of time may allow of the occupant 44 to experience the effects of the adjustment and evaluate the effectiveness. The ECU 40 may store a response to the follow up inquiry from the occupant 44 in an occupant profile.

In embodiments, an ECU (e.g., ECU 40) may include an electronic controller and/or include an electronic processor, such as a programmable microprocessor and/or microcontroller. In embodiments, an ECU may include, for example, an application specific integrated circuit (ASIC). An ECU may include a central processing unit (CPU), a memory (e.g., a non-transitory computer-readable storage medium), and/or an input/output (I/O) interface. An ECU may be configured to perform various functions, including those described in greater detail herein, with appropriate programming instructions and/or code embodied in software, hardware, and/or other medium. In embodiments, an ECU may include a plurality of controllers. In embodiments, an ECU may be connected to a display, such as a touchscreen display.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

It should be understood that an electronic control unit (e.g., ECU 40), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A seat assembly, including:
a seat having a seat base and a seat back;
an adjustment assembly connected to the seat;
an electronic control unit (ECU) connected to the seat and the adjustment assembly; and
a sensor assembly connected to the ECU;
wherein the ECU is configured to continuously receive audio in a vehicle cabin via the sensor assembly and to automatically control the adjustment assembly to adjust the seat.

2. The seat assembly of claim 1, wherein the ECU is configured to automatically control the adjustment assembly to adjust the seat according to the received audio independent of any static list of predetermined or stored voice commands or wake-up phrases.

3. The seat assembly of claim 1, including an audio filter unit connected to the ECU;
wherein the audio filter unit is configured to separate a voice of an occupant from ambient noise in said vehicle cabin.

4. The seat assembly of claim 3, wherein the received audio includes a first occupant voice, a second occupant voice, and the ambient noise; the audio filter unit is configured to substantially filter out the ambient noise from the first occupant voice to provide a first signal;
and the audio filter unit is configured to substantially filter out the ambient noise from the second occupant voice to provide a second signal.

5. The seat assembly of claim 4, wherein the ECU is configured to adjust the seat according to the first signal, and adjust a second seat according to the second signal.

6. The seat assembly of claim 1, wherein the adjustment assembly includes an audio unit.

7. The seat assembly of claim 1, wherein the adjustment assembly includes a seat position unit configured to adjust positions of the seat back and the seat base according to the received audio.

8. The seat assembly of claim 1, wherein the adjustment assembly includes a massage unit having one or more massagers disposed in at least one of the seat base and the seat back; and the ECU is configured to activate the one or more massagers according to the received audio.

9. The seat assembly of claim 1, wherein the adjustment assembly includes a temperature control unit; the ECU is configured to increase and decrease a temperature of said vehicle cabin via the temperature control unit; and the ECU is configured to control seat heating and seat ventilation functions of the temperature control unit that may be connected to the seat base and/or the seat back.

10. The seat assembly of claim 1, wherein the ECU is configured to identify an occupant in the seat via the sensor assembly.

11. The seat assembly of claim 10, wherein the sensor assembly includes a biometric sensor; and the ECU is configured to recognize a previous occupant via the biometric sensor.

12. A method of operating a seat assembly, including:
providing a seat, an electronic control unit (ECU), a sensor assembly, a microphone assembly disposed proximate the seat, and an adjustment assembly;
detecting an occupant in the seat via the sensor assembly;
continuously receiving audio via the microphone assembly; and
activating, via the ECU, the adjustment assembly to adjust the seat of the occupant according to the received audio.

13. The method of claim 12, wherein detecting the occupant includes (i) the ECU receiving information from a biometric sensor of the sensor assembly; (ii) comparing the information to a database stored in the ECU; and (iii) loading a respective occupant profile.

14. The method of claim 12, wherein detecting the occupant includes (i) the ECU receiving information from a biometric sensor of the sensor assembly; (ii) comparing the information to a database to identify a corresponding occupant profile; and (iii) creating an occupant profile for the corresponding occupant.

15. The method of claim 12, wherein the ECU is configured to receive information from the sensor assembly while the occupant is disposed in the seat.

16. The method of claim 12, including transmitting the received audio to a filter unit; wherein the filter unit is configured to filter out ambient noise from the received audio to isolate a voice of the occupant. m 17. The method of claim 12, wherein the received audio corresponds to a physical condition of the occupant.

18. The method of claim 12, wherein activating the adjustment assembly includes activating at least one of a seat position unit, a massage unit, a temperature control unit, and an audio unit.

19. The method of claim 12, including, after activating the adjustment assembly, automatically requesting and receiving, via the ECU, feedback from the occupant regarding the activation of the adjustment assembly.

20. The method of claim 19, wherein the ECU is configured to update a corresponding occupant profile with the feedback from the occupant; and the ECU is configured to use the feedback in determining future adjustments of the same occupant.
